(19) United States
(12) Patent Application Publication
(10) Pub. No.: US 2012/0237347 A1
(43) Pub. Date: Sep. 20, 2012

(54) Ram Air Turbine with Controlled Vibrational Resonances

(75) Inventors: Zaffir A. Chaudhry, Rockford, IL (US); William E. Seidel, Rockford, IL (US)

(73) Assignee: Hamilton Sundstrand Corporation, Windsor Locks, CT (US)

(21) Appl. No.: 13/051,213

(22) Filed: Mar. 18, 2011

(51) Int. Cl. F03D 11/04

(52) U.S. Cl. 416/149

(57) ABSTRACT

A ram air turbine with a strut that is pivotable through a pivot plane about a pivot point on the strut from a generally horizontal rearward rest position to a generally vertical central operating position comprises at least one movable brace that extends between a stationary brace mounting point and a brace support point on the strut below the pivot point.

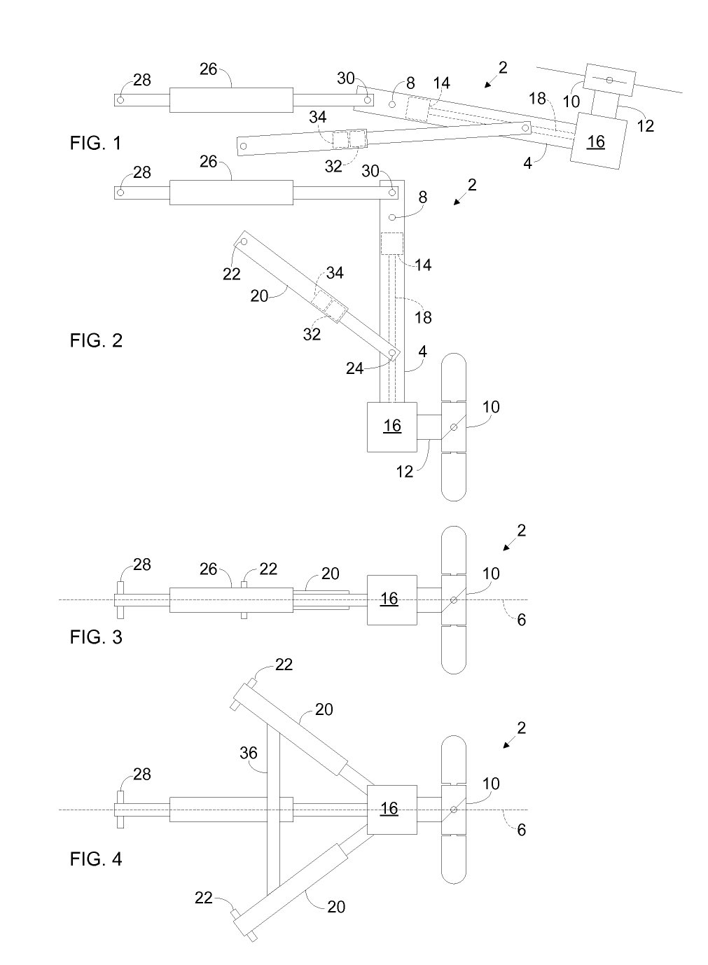

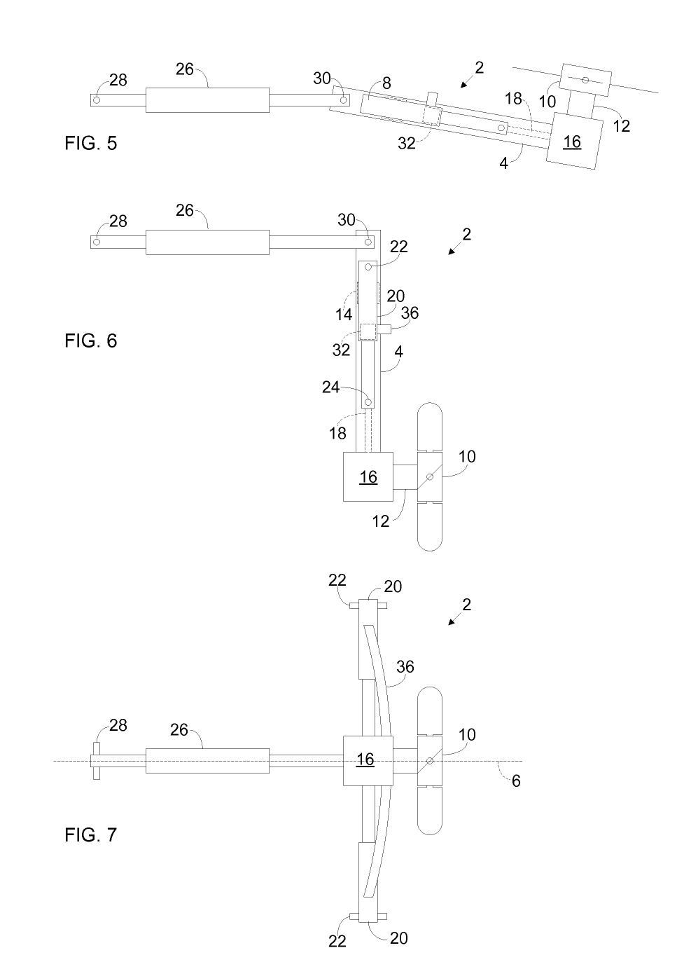

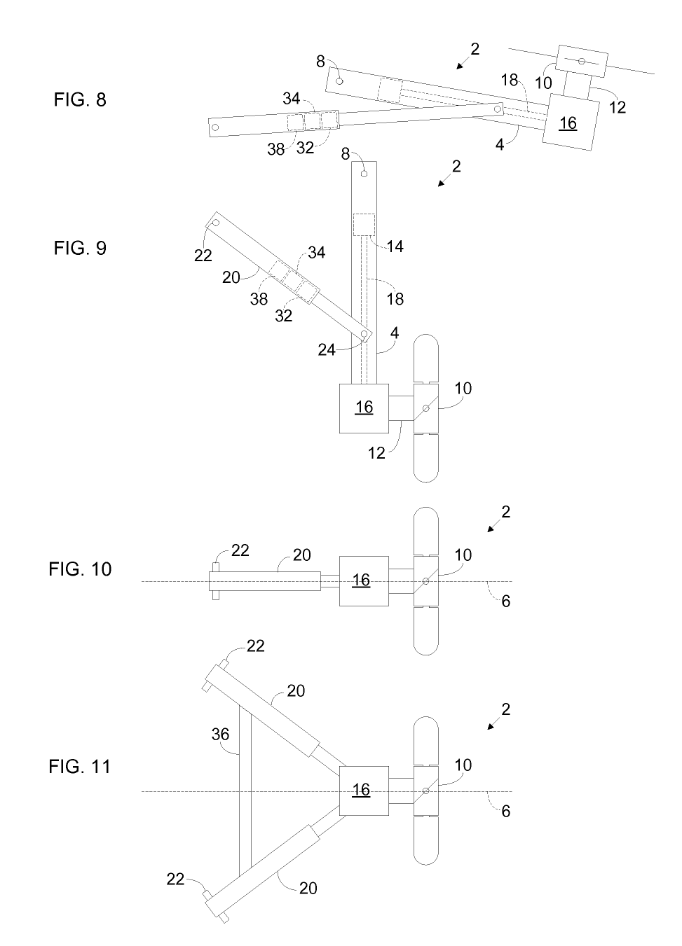

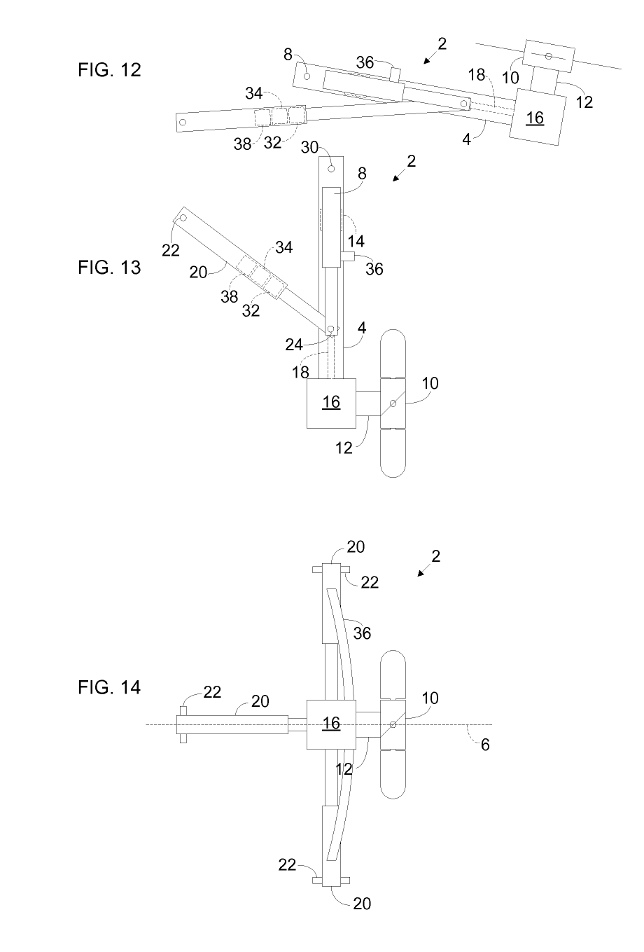

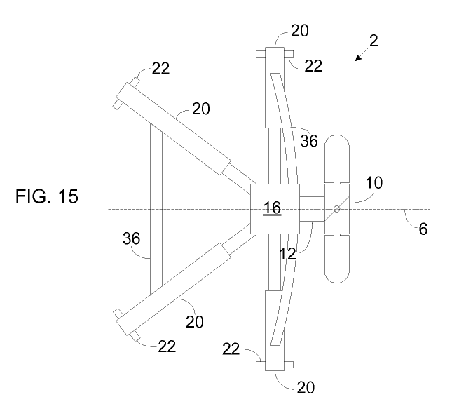

FIG. 1 is a side view of a ram air turbine according to a first possible embodiment in a rest position. FIG. 2 is a side view of a ram air turbine according to a first possible embodiment in an operating position. FIG. 3 is a bottom view of a ram air turbine according to a first possible embodiment in an operating position with a single telescoping brace. FIG. 4 is a bottom view of a ram air turbine according to a first possible embodiment in an operating position with two telescoping braces. FIG. 5 is a side view of a ram air turbine according to a second possible embodiment in a rest position. FIG. 6 is a side view of a ram air turbine according to a second possible embodiment in an operating position. FIG. 7 is a bottom view of a ram air turbine according to a second possible embodiment in an operating position. FIG. 8 is a side view of a ram air turbine according to a third possible embodiment in a rest position. FIG. 9 is a side view of a ram air turbine according to a third possible embodiment in an operating position. FIG. 10 is a bottom view of a ram air turbine according to a third possible embodiment in an operating position with a single telescoping brace. FIG. 11 is a bottom view of a ram air turbine according to a third possible embodiment in an operating position with two telescoping braces. FIG. 12 is a side view of a ram air turbine according to a fourth possible embodiment of in a rest position. FIG. 13 is a side view of a ram air turbine according to a fourth possible embodiment in an operation position. FIG. 14 is a bottom view of a ram air turbine according to a fourth possible embodiment in an operation position with a single telescoping brace. FIG. 15 is a bottom view of a ram air turbine according to a fourth possible embodiment in an operating position with two telescoping braces.

FIG. 1 is a side view of a ram air turbine 2 according to a first possible embodiment in a rest position. FIG. 2 is a side view of the ram air turbine 2 according to the first possible embodiment in an operating position. FIGS. 3 and 4 are two possible bottom views of the ram air turbine 2 according to the first possible embodiment of the invention in the operating position. Referring to FIGS. 1 through 4 together, the ram air turbine 2 has a strut 4 that is pivotable through a pivot plane 6 about a central pivot point 8 along the strut 4. The strut 4 carries a turbine 10 that extends from a distal end 12 of the strut 4. The turbine 10 couples to a power-generating source 14, such as an electric generator or hydraulic motor, within the strut 4 proximate the pivot point 8 by means of a gearbox 16 on the strut 4 and internal shaft 18 within the strut 4. At least one movable brace 20 extends between a stationary brace mounting point 22 and a brace support point 24 on the strut 4 below the pivot point 8, between the pivot point 8 and the distal end 12 of the strut 4.

An actuator 26, such as a spring-powered actuator, extends between a forward stationary actuator mounting point 28 and an actuation point 30 on the strut 4 above the pivot point 8. In the first embodiment, the at least one movable brace 20 comprises at least one telescoping movable brace and the stationary brace mounting point 22 comprises a forward stationary brace mounting point so that operation of the actuator 26 may pivot the strut 4 through the pivot plane 6 from a generally horizontal rearward rest position, as shown in FIG. 1, to a generally vertical central operating position, as shown in FIG. 2. The at least one movable brace 20 may comprise a single telescoping movable brace that generally remains within the pivot plane 6, which may also comprise a snubber 32, a down lock 34, or both, as shown in FIG. 3. Alternatively, the at least one movable brace 20 may comprise two telescoping movable braces, one on each side of the pivot plane 6, each of which may also comprise the snubber 32, the down lock 34, or both, as shown in FIG. 4. Further, a cross brace 36 may extend between the two telescoping movable braces 20, as shown in FIG. 4.

FIG. 5 is a side view of the ram air turbine 2 according to a second possible embodiment in the rest position. FIG. 6 is a side view of the ram air turbine according to the second possible embodiment in the operating position. FIG. 7 is a bottom view of the ram air turbine 2 according to the second embodiment in the operating position. Referring to FIGS. 5 through 7 together, the at least one movable brace 20 comprises two rigid movable braces, one on each side of the pivot plane 6, and the stationary brace mounting point 22 for each of the rigid movable braces 20 is a central stationary brace mounting point so that operation of the actuator 26 may pivot the strut 4 through the pivot plane 6 from the generally rearward rest position, as shown in FIG. 5, to the generally vertical central operating position, as shown in FIG. 6. Each of the rigid movable braces 20 may comprise the snubber 32 and the cross braces 36 may extend between the two rigid movable braces 20, as shown in FIG. 7.

FIG. 8 is a side view of the ram air turbine 2 according to a third possible embodiment in the rest position. FIG. 9 is a side view of the ram air turbine 2 according to the third possible embodiment in the operating position. FIGS. 10 and 11 are two possible bottom views of the ram air turbine 2 according to the third possible embodiment in the operating position. Referring to FIGS. 8 through 11 together, the at least one movable brace 20 comprises at least one telescoping movable brace with a brace actuator 38, such as a spring-powered actuator, and the stationary brace mounting point 22 for the at least one telescoping movable brace 20 is a forward stationary brace mounting point so that operation of the brace actuator 38 may pivot the strut 4 through the pivot plane 6 from the generally rearward rest position, as shown in FIG. 8, to the generally vertical central operating position, as shown in FIG. 9. The at least one telescoping movable brace 20 may comprise a single telescoping movable brace 20 that generally remains within the pivot plane 6, which may also comprise the snubber 32, the down lock 34, or both, as shown in FIG. 10. Alternatively, the at least one telescoping movable brace 20 may comprise two telescoping movable braces 20, each of which may also comprise the snubber 32, the down lock 34, or both, as shown in FIG. 11. Further, the cross brace 36 may extend between the two telescoping movable braces 20, as shown in FIG. 11.

FIG. 12 is a side view of a fourth possible embodiment in the rest position. FIG. 13 is a side view of the fourth possible embodiment in the operating position. FIGS. 14 and 15 are two possible bottom views of the ram air turbine 2 according to the fourth possible embodiment in the operating position. Referring to FIGS. 12 through 15 together, the at least one movable brace 20 comprises two rigid movable braces, one on each side of the pivot plane 6, and the stationary brace mounting point 22 for each of the rigid movable braces 20 is a central stationary brace mounting point, as well as at least one telescoping moving brace with the brace actuator 38, and the stationary for mounting point 22 for the at least one telescoping movable brace 20 is a forward stationary brace mounting point so that the operation of the brace actuator 38 may pivot the strut 4 through the pivot plane 6 from the generally rearward rest position, as shown in FIG. 12, to the generally vertical central operating position, as shown in FIG. 9. The at least one telescoping movable brace 20 may comprise a single telescoping movable brace that generally remains within the pivot plane 6, which may also comprise the snubber 32, the down lock 34, or both, as shown in FIG. 14. Alternatively, the at least one telescoping movable brace 20 may comprise two telescoping movable braces, each of which may also comprise the snubber 32, the down lock 34, or both, as shown in FIG. 15. Further, the cross brace 36 may extend between the two rigid movable braces 20, as shown in FIGS. 14 and 15, as well as between the two telescoping movable braces 20, as shown in FIG. 15.

In all the described embodiments, the movable braces 20 as well as the cross braces 36 increase the structural rigidity of the ram air turbine 2 in the operating position. The increased structural rigidity adds strength as well as increases the frequencies for the natural vibrational resonances of the ram air turbine 2 to a range wherein operation of the ram air turbine 2 cannot induce oscillation of the ram air turbine 2. It is possible to adjust the natural vibrational resonances of the ram air turbine 2 by way of adjusting the position of the brace support point 24 for the movable braces 20 along the strut. That is, moving the support point 24 closer to the distal end 12 of the strut 4 will increase the natural vibrational resonances and moving the support point 24 closer to the pivot point 8 of the strut 4 will lower them.

Thus, it is possible to mount even a large turbine 10 onto the ram air turbine 2 without danger that natural vibrational frequencies of the turbine 10 will lie within its range of operating speeds. Alternatively, the movable braces 20 allow the strut 4 of a conventional size ram air turbine 2 to have reduced size and mass with the same benefit of raising the natural vibrational resonances above its range of operating speeds.

The positioning of the brace support point 24 for the movable braces 20 below the position of the power-generating source 14 in the strut 4 removes the power-generating source 14 from the load path for the ram air turbine 2. The movable braces 20 and the cross braces 36 may also have tapers, contours, or both, that increase their rigidity and improve aerodynamic efficiency. The snubbers 32 in the movable braces 20 may further increase resonant frequencies of the ram air turbine 2 as well as dampen them. The down locks 34 in the telescoping movable braces 20 may further increase rigidity of the telescoping movable braces 20 when they extend to the point that the strut 4 is in the operating position.

The described embodiments as set forth herein represents only some illustrative implementations of the invention as set forth in the attached claims. Changes and substitutions of various details and arrangement thereof are within the scope of the claimed invention.

1. A ram air turbine with a strut that is pivotable through a pivot plane about a pivot point on the strut from a generally horizontal rearward rest position to a generally vertical central operating position, comprising:
at least one movable brace that extends between a stationary brace mounting point and a brace support point on the strut below the pivot point.

2. The ram air turbine of claim 1, further comprising an actuator that extends between a forward stationary actuator mounting point and an actuation point on the strut above the pivot point.

3. The ram air turbine of claim 2, wherein the at least one movable brace comprises a single telescoping movable brace that generally remains within the pivot plane and the stationary brace mounting point comprises a forward stationary brace mounting point.

4. The ram air turbine of claim 3, further comprising a snubber within the single telescoping movable brace.

5. The ram air turbine of claim 3, further comprising a down lock within the single telescoping movable brace.

6. The ram air turbine of claim 2, wherein the at least one movable brace comprises two telescoping movable braces, one on each side of the pivot plane, and the stationary brace mounting point for each of the two telescoping movable braces comprises a forward stationary brace mounting point.

7. The ram air turbine of claim 6, further comprising a snubber in at least one of the two telescoping movable braces.

8. The ram air turbine of claim 6, further comprising a down lock in at least one of the two telescoping movable braces.

9. The ram air turbine of claim 6, further comprising a cross brace that extends between the two telescoping movable braces.

10. The ram air turbine of claim 2, wherein the at least one movable brace comprises two rigid movable braces, one on each side of the pivot plane, and the stationary brace mounting point for each of the two rigid movable braces comprises a central stationary brace mounting point.

11. The ram air turbine of claim 10, further comprising a snubber in at least one of the two rigid movable braces.

12. The ram air turbine of claim 10, further comprising a cross brace that extends between the two rigid movable braces.

13. The ram air turbine of claim 1, wherein the at least one movable brace comprises at least one telescoping movable brace with a brace actuator and the stationary brace mounting point comprises a forward stationary brace mounting point.

14. The ram air turbine of claim 13, wherein the at least one telescoping movable brace comprises a single telescoping movable brace that generally remains within the pivot plane.

15. The ram air turbine of claim 14, further comprising a snubber within the single telescoping movable brace.

16. The ram air turbine of claim 14, further comprising a down lock within the single telescoping movable brace.

17. The ram air turbine of claim 13, wherein the at least one movable brace comprises two telescoping movable braces, one on each side of the pivot plane.

18. The ram air turbine of claim 17, further comprising a snubber in at least one of the two telescoping movable braces.

19. The ram air turbine of claim 17, further comprising a down lock within at least one of the two telescoping movable braces.

22. The ram air turbine of claim 17, further comprising a cross brace that extends between the two telescoping movable braces.

23. The ram air turbine of claim 13, wherein the at least one movable brace further comprises two rigid movable braces, one on each side of the pivot plane, and the stationary brace mounting point for each of the two rigid braces comprises a central stationary brace mounting point.

24. The ram air turbine of claim 23, further comprising a snubber in at least one of the two rigid braces.

25. The ram air turbine of claim 23, further comprising a cross brace that extends between the two rigid braces.

26. The ram air turbine of claim 23, wherein the at least one telescoping movable brace comprises a single telescoping movable brace that generally remains within the pivot plane.

27. The ram air turbine of claim 26, further comprising a snubber within the single telescoping movable brace.

28. The ram air turbine of claim 26, further comprising a down lock within the single telescoping movable brace.

27. The ram air turbine of claim 23, wherein the at least one movable brace comprises two telescoping movable braces, one on each side of the pivot plane.

28. The ram air turbine of claim 27, further comprising a snubber in at least one of the two telescoping movable braces.

29. The ram air turbine of claim 27, further comprising a down lock within at least one of the two telescoping movable braces.
